(19) United States
(12) Patent Application Publication
(10) Pub. No.: US 2026/0023176 A1
(43) Pub. Date: Jan. 22, 2026

(54) 3D IMAGING SONAR SYSTEM AND METHOD

(71) Applicant: Nortek AS, Rud (NO)

(72) Inventor: Audun RAMSTAD, Rud (NO)

(73) Assignee: Nortek AS, Rud (NO)

(21) Appl. No.: 19/050,990

(22) Filed: Feb. 11, 2025

Related U.S. Application Data
(60) Provisional application No. 63/672,074, filed on Jul. 16, 2024.

(51) Int. Cl. G01S 15/89; G01S 15/58

(52) U.S. Cl. CPC G01S 15/89; G01S 15/582; G01S 15/588

(57) ABSTRACT

A system and method for generating three-dimensional (3D) images using sonar technology comprises a circular phased array to create 3D point clouds from the echoes of a single sonar ping and may be configured to measure Doppler shift. The circular phased array is a circular receiver array that is combined with a single, wide opening angle projector that transmits at least one pulse of acoustic energy. The echoes from this pulse are received by the circular array. The signals from the receiver elements are combined using Delay and Sum beamforming processes to perform spatial filtering with resolution as discussed above. The system and method combine advantages of Mills Cross systems and square arrays, providing high-resolution, instantaneous 3D imaging employing a 1D array, leading to a more efficient and scalable design.

### CROSS-REFERENCE TO RELATED APPLICATION

This application claims the benefit of prior U.S. Provisional Patent Application No. 63/672,074, filed Jul. 16, 2024, under 35 U.S.C. 119, which is incorporated by reference herein.

### FIELD OF THE INVENTION

The present invention relates to imaging sonars, specifically to systems and methods for generating three-dimensional (3D) images using sonar technology.

### BACKGROUND OF THE INVENTION

Accurately representing underwater environments in three dimensions (3D) is crucial for applications such as underwater navigation, mapping, and object detection. Traditional sonar systems have used various array configurations to achieve this goal, each with its advantages and limitations.

One common configuration is the Mills Cross array, which employs linear, i.e., one-dimensional, transducer arrays. Mills Cross type instruments, while effective, have notable limitations:
Downward Looking Multibeam Echo Sounder (MBES): This configuration scans lines perpendicular to the direction of travel as the measurement platform moves forward. While MBES systems can provide 3D information, they do so by scanning one line at a time. The platform must traverse the area to be mapped, which can be time-consuming and limits the ability to capture dynamic changes in the environment.
Forward Looking Sonar: This type of sonar constructs 2D projections of the scene from a slanted beam transmitted towards the bottom. Although forward-looking sonar can generate an image from a single ping of transmission, these images are only two-dimensional. They lack the depth information required for comprehensive 3D mapping, making them less useful for applications requiring detailed spatial understanding.

Another approach to 3D sonar imaging involves the use of square phased arrays. With these arrays, narrow receive beams can be steered in arbitrary directions, allowing for the generation of 3D point clouds from the echoes of a single sonar ping. Square arrays can produce beams that are narrow in two directions as opposed to linear arrays which produce (fan-shaped) beams that are narrow in one direction and wide in the perpendicular direction. The beamwidth scales inversely with the aperture dimensions, which, with half a wavelength element spacing, translates to the number of elements, N. For a square array to achieve the same beamwidth as an N-element linear array, N² elements would be required. This results in complex and expensive electronics, particularly as the resolution increases.

### SUMMARY OF THE INVENTION

An aspect of the present disclosure involves a 3D imaging sonar system that addresses these limitations by utilizing a circular phased array instead of the traditional square array or Mills Cross configuration. The circular array has the same ability to steer narrow beams in arbitrary directions as a square array, but with significantly fewer elements, simplifying the electronic requirements and improving scalability.

To illustrate the advantages of the circular array, a comparison is made between circular and linear (or square) arrays with respect to sidelobe levels, main lobe width, shading, and array sparsity. To achieve the same main lobe width as a linear array, a circular array with approximately 2.5 times the number of elements would be required, assuming the same sparsity for both arrays. For unshaded configurations, the maximum sidelobe level of a linear array is approximately-13 dB, whereas the sidelobe level for a circular array is approximately-8 db. When considering thinning the array (making it a sparse array), the circular array demonstrates significantly reduced grating lobes, making it more advantageous for applications requiring sparse array configurations. A comparison of circular arrays to linear or square arrays thus depends on the tolerance for sidelobes and the practicality of thinning the array for the particular application. In the following, we shall refer to linear and circular arrays both as N-element arrays and square arrays as N²-element arrays. Those skilled in the art will recognize that the exact scaling also depends on array sparsity.

With simple amplitude shading, there is limited ability to move energy from the sidelobes to the main lobe for a circular array, unlike linear arrays. However, there are techniques to redistribute the energy within the sidelobe structure, such as focusing it in specific azimuth directions. This capability opens up possibilities for adaptive techniques where sidelobes are manipulated, allowing detection algorithms to benefit from the stability of the main lobe response.

The circular array offers a 1/N versus 1/√N scaling advantage over square arrays when moving to higher resolutions. This improved scalability means that as the desired resolution increases, the circular array requires significantly fewer elements relative to the square array, resulting in simplified electronics and reduced cost. In addition, post-processing techniques such as deconvolution using the known directivity function can be applied to further reduce sidelobe levels, enhancing image quality and target detection.

This improved scalability, reduced grating lobes, and the ability to adapt sidelobe energy distribution make the circular array a compelling alternative to traditional linear or square arrays, especially in high-resolution imaging applications.

A circular receiver array is combined with a single, wide opening angle projector that transmits at least one pulse of acoustic energy. The echoes from this pulse are received by the circular array. The signals from the receiver elements are combined using for instance Delay and Sum beamforming algorithms to perform spatial filtering with resolution as discussed above.

This innovative approach offers the combined advantages of Mills Cross systems and square arrays, providing high-resolution, single-ping 3D imaging employing a 1D array, leading to a more efficient and scalable design.

### BRIEF DESCRIPTION OF DRAWINGS

The accompanying drawings, which are incorporated in and form a part of this specification illustrate embodiments of the invention and together with the description, serve to explain the principles of the invention.

FIG. 1 is a perspective view of an embodiment of a 3D imaging sonar system including a circular hydrophone transducer array.

FIG. 2A is a top plan view of the 3D imaging sonar system of FIG. 1 and FIG. 2B shows a detail of the receiver array indicated by the rectangle in FIG. 2A.

FIG. 3 is a cross-sectional view of the 3D imaging sonar system of FIG. 1.

FIG. 4 is a block diagram of electronics of the 3D imaging sonar system.

FIG. 5 shows a wide angle transmit beam and a narrow receive beam of the 3D imaging sonar system of FIG. 1 projected onto a flat surface.

FIG. 6 shows another embodiment of a 3D imaging sonar system where the receiver array comprises multiple concentric circular arrays.

FIG. 7 is an exemplary flow chart of a process to generate a 3D point cloud from a single ping.

FIG. 8 is an exemplary flow chart of a combined process to generate a 3D point cloud from a single ping and find Doppler shifts.

### DESCRIPTION OF EMBODIMENTS OF THE INVENTION

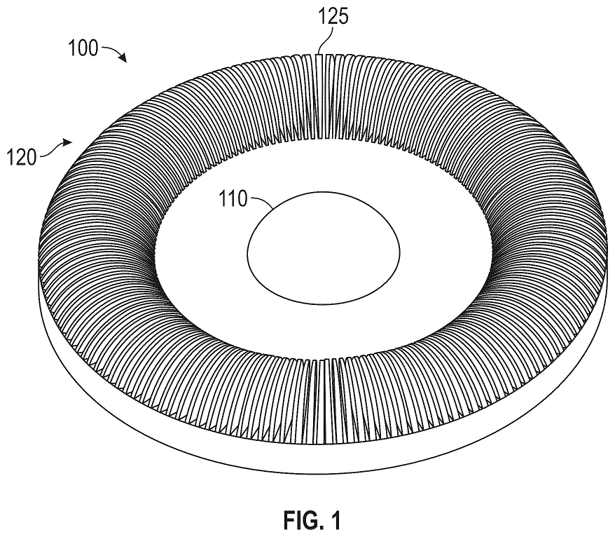

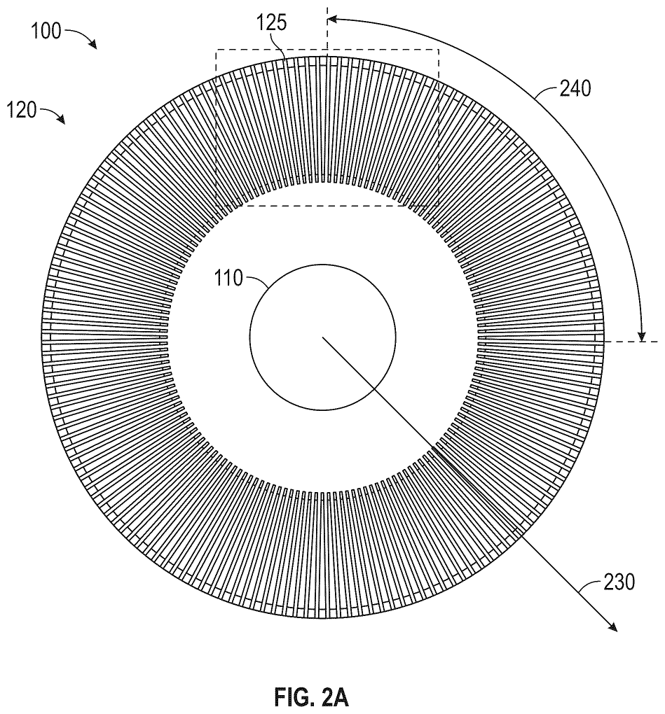

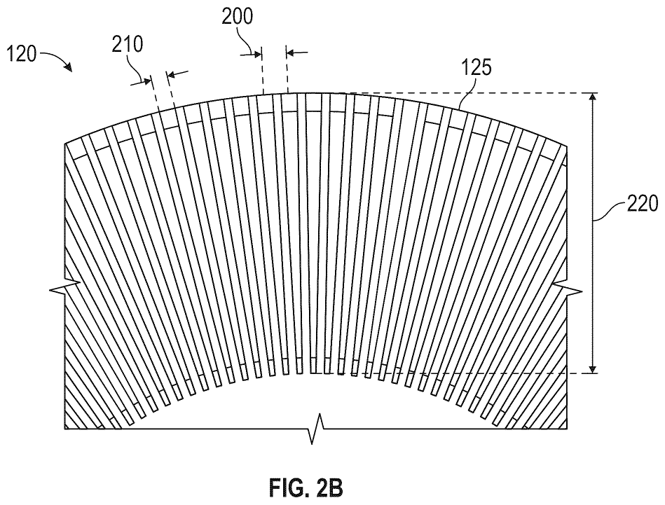

With reference to FIGS. 1-4, an embodiment of a 3D imaging sonar system 100 includes a wide-angle projector 110 and circular hydrophone transducer array 120 with large area curved surfaces. Individual hydrophone array transducer elements 125 are spaced one half wavelength of the center frequency. The circular hydrophone transducer array 120 forms a large surface area receiver with the hydrophone circular array around the wide-angle projector 110.

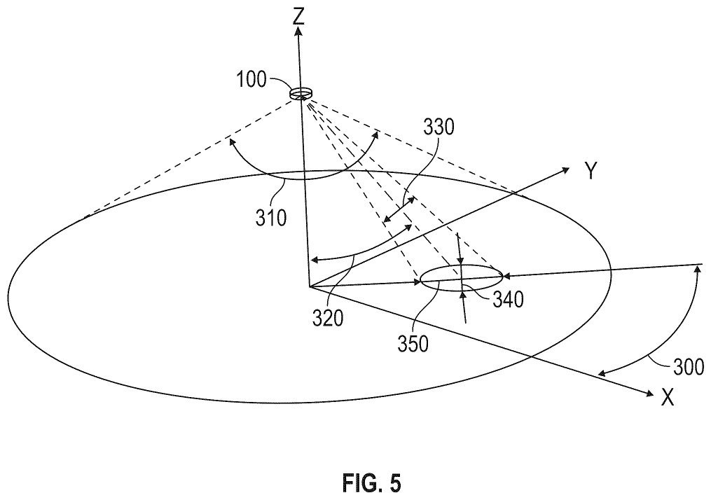

The wide-angle projector (“projector”) 110 is a central, dome-shaped transducer that transmits pulses of acoustic energy into the underwater environment. The projector 110 is designed to cover a wide area with a single pulse, ensuring comprehensive coverage. A wide opening angle is achieved either by using small aperture dimensions, a curved transducer surface, or a phased array (e.g., concentric rings). Combinations of these techniques may also be employed, such as one narrow dimension and curvature along the perpendicular direction as illustrated for the projector 110 in FIG. 6. The design of wide-angle projectors is well known in the art. The projector 110 is designed to cover, by some margin, the desired angular coverage of the imaging system.

The circular hydrophone transducer array 120 comprises the hydrophone array transducer elements (“transducer elements”) 125 arranged in a circular pattern. The transducer elements 125 receive the echoes of the transmitted pulse. The circular arrangement allows for effective beam steering in arbitrary directions, similar to square arrays but with reduced complexity. To obtain a large surface area while maintaining large opening angles, the circular hydrophone transducer array 120 in certain embodiments takes the form of a toroidal section. The transducer elements 125 are spaced at minimum half a wavelength of the center frequency of the transmitted signal. Unlike traditional square arrays, where the resolution is inversely proportional to the square root of the number of elements (1/√N), the circular array's angular resolution is inversely proportional to the number of elements (1/N). In other words, if N² elements are needed to obtain a certain resolution for a square array, one could achieve the same resolution with roughly N elements using a circular array, leading to simplified electronics and better scalability.

The transducer elements 125 are positioned along the circumference of the circular hydrophone transducer array 120. The transducer elements 125 may be optimized as hydrophone elements (for reception only). The approximately half-wavelength pitch 200 along the circumference dictates element width 210 smaller than half a wavelength, resulting in a wide opening angle in the azimuth direction 240. In the radial direction 230, the element length 220 may be larger than half a wavelength to approximately match the opening angle of the projector 110. To achieve increased sensitivity, the radial element dimension 220 may be increased further. A surface curvature, out of the plane of the circle, may be required to maintain the elements' desired opening angle.

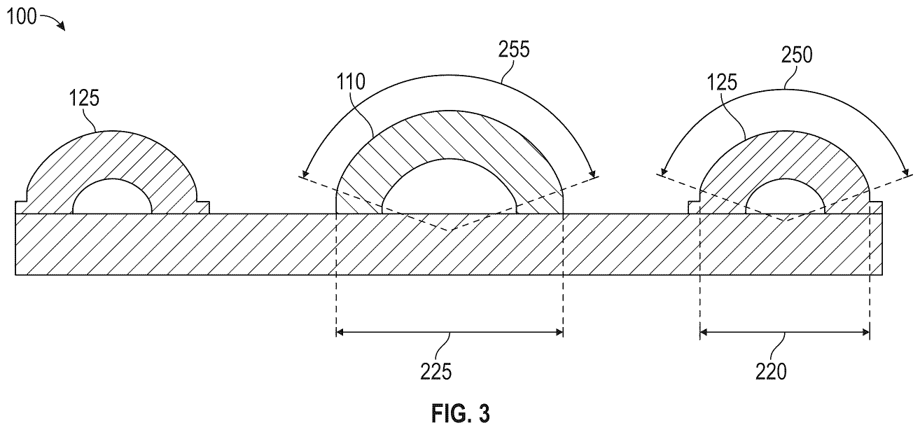

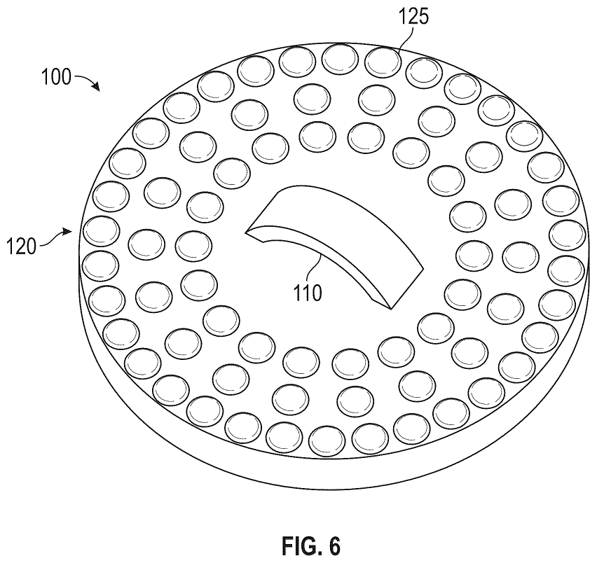

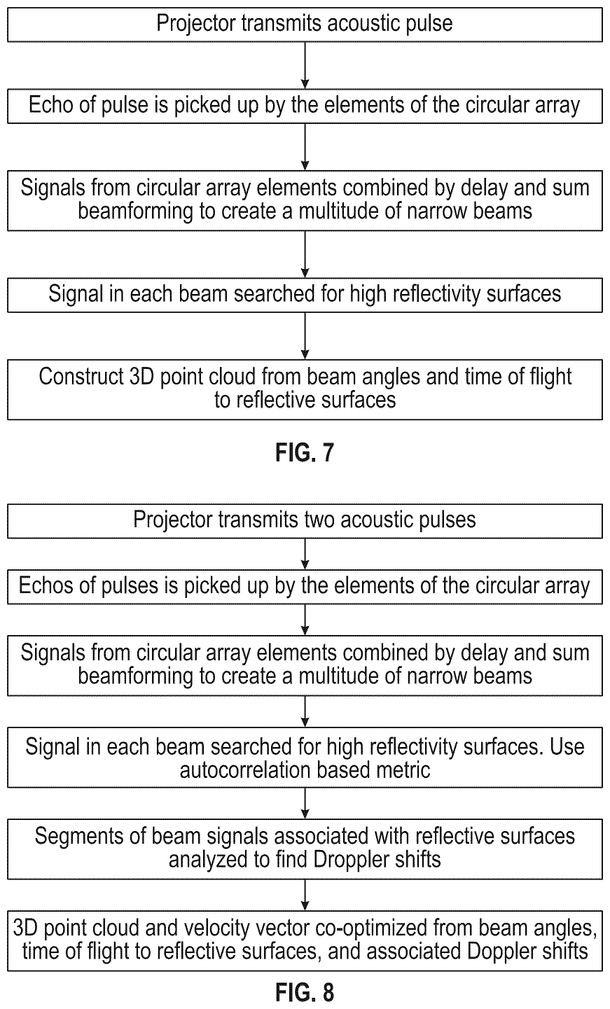

FIG. 4 is a block diagram of beam steering and signal processing electronics 140 of the 3D imaging sonar system 100. These electronics control the phased array 120, steer the beams, and process the received signals to construct the 3D point cloud. The reduced number of elements in the circular array 120 simplifies the design and operation of the electronics 140. All signal processing, as depicted, is performed in the digital domain. In certain embodiments, additional signal processing, such as filtering, may be conducted in the analog domain. The digital signal processing occurs in the block labeled CPU 130. In a practical system, this block may comprise several different processors, such as an FPGA, DSP, CPU, GPU, NPU, etc. Following the process(es) described below with respect to FIGS. 7 and 8, the signal shape, for instance, a wide-band chirp, is initially defined in the CPU block before being converted to an analog signal, amplified, and finally transmitted to the projector 110. The echoes returned from the water are received by the hydrophone array 120. The signal from each element 125 is amplified and digitized in the pre-amp/DAC block and passed as individual data streams to the CPU 130, where beamforming, detection, and Doppler processing are performed. Thus, the CPU 130 defines the signal to be projected by the projector 110 and also does beam shaping and detection of the signals received by the elements 125 of the circular hydrophone array 120. Combined with an Inertial Measurement Unit (IMU), the system 100 forms a comprehensive navigation and mapping system applicable to various subsea exploration fields, including biology, archaeology, infrastructure, minerals, and general seabed mapping.

The steps of a method or algorithm described in connection with the embodiments disclosed herein can be embodied directly in hardware, in a software module executed by a processor (e.g., CPU 130), or in a combination of the two. A software module can reside in any other form of computer readable medium/storage medium and the storage medium can be integral to the processor. The software, when executed by the processor, causes the processor to perform the inventive features and functions described herein.

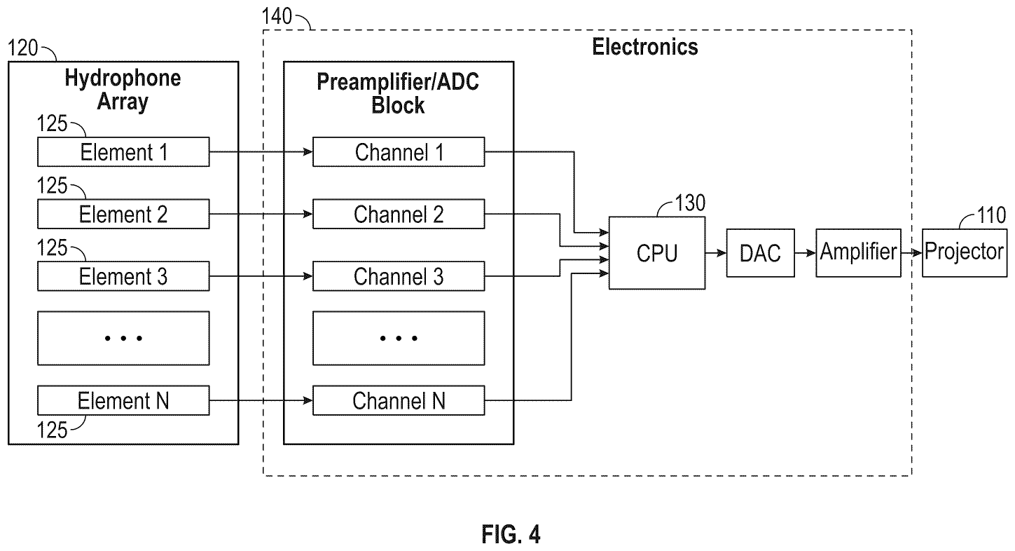

FIG. 5 shows the transmit and receive beams projected from the 3D imaging sonar system 100 onto a flat surface such as the seabed. The transmitted beam from the projector 110 has a wide opening angle 310 in order to ensonify a large area of the surface to be imaged. An example of a receive beam formed by beam steering in the CPU 130 from the signals received by the hydrophone array 120 is also shown. It is steered to an azimuth angle 300 and elevation angle 320. The opening angle 330 of the receive beam is much smaller than the projector's opening angle 310, producing a focus characterized by a radial length 350 and azimuth width 340. The image resolution is given by the inverse of this focal spot size. For each ping of the projector 110, the steering angles 300 and 320 are scanned over the ensonified area to create a 3D point cloud.

In one or more embodiments, the wide-angle projector 110 is a curved surface transducer, which can take the form of a spherical section (as shown in FIGS. 1-3), a cylindrical section (as in FIG. 6), or an arbitrary curved surface optimized to complement the directivity of the receiver array. The transducer elements 125 disposed along a circle, spaced approximately half the wavelength of the center frequency of the transmitted signal, ensures the ability to steer beams in arbitrary directions without creating unwanted grating lobes. The imaging resolution is given by the outer radius of the receiver array 120. For a given element pitch 200, this yields the number of elements 125 in the receiver array. The spot size of an N-element circular array is narrower than that of a piston of the same radius but wider than an N×N square array.

In a basic embodiment, the transducer elements 125 have flat surfaces. The width 210 along the azimuth direction 240 is approximately half a wavelength, and the length 220 along the radial direction 230 may be somewhat longer than the width 210. The length 220 is limited by the desired image opening angle. The longer the element, the larger the loss at maximum steering angle. Already at one wavelength, the loss will be more than 6 dB at 40 degrees.

Compared with an N×N element square hydrophone array, an N element circular array would have a much smaller (1/N) surface area provided the individual transducer elements 125 are the same size. This will reduce the signal-to-noise ratio (SNR) of the received signal proportionally. Elongation of the flat transducer elements 125 in the radial direction 230 cannot compensate for this without dramatically effecting the ability to steer beams in arbitrary directions. Therefore, in one preferred embodiment, the transducer elements 125 have a curvature out of the plane of the circle along the radial direction as shown in FIGS. 1-3. This curvature 250 can be optimized to achieve the desired element directivity, ideally similar or complementary to the directivity of the projector 110, given in some embodiments by its curvature 255. Instead of a flat ring, the hydrophone array 120 now constitutes a structure protruding out of the surface plane, such as a cross-section of a torus parallel to its equatorial plane. In this way, the total surface area of the hydrophone array 120, and hence the SNR, may be constructed equal to that of a square (N×N) array with the same angular resolution, without loss of steerability.

The half-wavelength element pitch 200 is not a strict requirement for a circular array. Thinning to at least half the number of elements (resulting in one wavelength spacing) is possible without introducing grating lobes on the level of the existing sidelobes. However, increasing the element spacing will reduce the array's total surface area and consequently the signal-to-noise ratio (SNR). This may require introducing curvature to the element surface also in the azimuth direction 240 to allow increasing element width 210 without compromising the array's steerability.

Beam steering for circular arrays is well described in the literature. To steer a beam in the direction given by angle θ and ϕ, the signals from each element, n, is delayed by a time Tn. The time delayed signals are then summed to produce the signal that would have been received by a narrow beam pointing in the direction (θ, ϕ). The time delay for element n is given by

$${T}_{n} = - 1 / c \cdot ( {x}_{n} sin θcos φ + {y}_{n} sin θsin φ ) ,$$

where c is the sound velocity, θ is the zenith or elevation angle 320 with θ=0 being perpendicular to the array, ϕ is the azimuth angle 300, and xₙ and yₙ are the coordinates of array element n given by xₙ=R cos φₙ, yₙ=R sin φₙ. R is the array radius and φₙ is the element's azimuth angle. Inserting the expressions for xₙ and yₙ into the expression for the time delay, we find

$${T}_{n} = - R / c sin θcos ( φ - {φ}_{n} ) .$$

In embodiments where the transmitted signal is a wideband signal, the application of the time delays is most readily done by resampling the element signals using interpolation techniques. Summing the resampled element signals to form beams is known in the art as Delay and Sum (DAS) beamforming.

In embodiments where the transmitted signal is a narrowband signal, the application of if the time delays may be approximated by multiplication by a phase factor. This is exact in the limit of a single frequency (harmonic) signal. The phase factor is given by ein, with

$${Φ}_{n} = - kR sin θcos ( φ - {φ}_{n} ) ,$$

where k is the wavenumber of the narrowband signal. For each spatial direction (θ, ϕ), the set of phase factors, e^{iΦ}^{ₙ}, form a steering vector. The beam signal at any time sample is found as the dot product between the steering vector and the vector formed by the element signals samples at that time sample. Whether DAS beamforming is required or if the steering vector approximation is applicable in a given embodiment depends on the bandwidth of the transmit signal and the need for accurate shaping and steering of beams.

In some prior art systems, the receiver array is not quadratic but rectangular. This configuration is suitable for applications where higher resolution along one axis is required or where the available space dictates a different aspect ratio. Moving from a linear/quadratic to a circular array configuration, the equivalent to a rectangular receiver array is an elliptical array. As used herein, circular arrays includes elliptical arrays and oval arrays (or other geometries that are essentially circular, and/or when the array performance is essentially that of a circular array).

In certain embodiments, the 3D imaging sonar system 100 comprises multiple circular arrays 120 (e.g., multitude concentric circular arrays 120). This configuration is particularly useful for multi-frequency systems, where lower frequency elements are larger, resulting in a larger circumference for the same number of elements. Multiple receiver arrays, optimized for different frequencies, may thus be organized as concentric circular arrays. In such multi-frequency embodiments, there may be a need for more than one transmitter/projector 110 where each transmitter/projector 110 is optimized for operation in its own frequency band. FIG. 6 shows a projector 110 shaped as a cylindrical section. This common projector design is well suited when the sonar system 100 comprises multiple projectors at multiple frequencies.

As shown in FIG. 6, in certain embodiments, a small number (typically 2-7) of concentric circular arrays 120 may operate in the same frequency band. Multiple concentric circular receiver arrays 120 can offer better sidelobe suppression, increased beam shaping flexibility, and improved SNR through increased transducer surface area. The addition of concentric circular arrays 120 does not necessarily imply more array elements compared to a single circular array. Starting with a single circular array, one may move elements from this array to new arrays at smaller radii without introducing significant grating lobes. When distributing the elements 125 between multiple circular arrays 120, the element pitch 200 increases and may approach the radial distance between the circular arrays. In such cases, individual elements 125 may be designed with hemispherical dome shape as in FIG. 6 rather than the toroidal sections in FIGS. 1-3. In certain embodiments, the element spacing in any direction may reach 10 wavelengths. Hemispherical elements 125 is then a good way to maintain a large surface area without sacrificing steerability. The design process of such an array may be approached as an optimization problem where the radius and number of elements for each concentric circular array is varied to achieve an optimal compromise e.g., between main lobe width, maximum side lobe level, and total side lobe energy. Amplitude shading, implemented e.g., as a fixed gain factor for each concentric circular array, may also be part of this optimization. Typical optimization constraints may include the total number of array elements and the overall size (outer radius) of the 3D imaging sonar system 100. There are numerous mathematical optimization methods that may be applied to this problem. Common to all of these is the formulation of a cost function that measures how well the compromise between performance factors (beam width, side lobe levels etc.) suitable for the given application is satisfied. The constraints (array size, number of elements etc.) may also be implemented as part of this cost function or more directly within the optimization algorithm. Typically, one will not be able to calculate the derivatives of such a cost function. Optimization is then done with a derivative-free algorithm, such as, but not limited to, Nelder-Mead Simplex, Genetic Algorithms, Particle Swarm Optimization, and Simulated Annealing.

It is well known in the art that with sparse arrays, irregular element spacing may be advantageous. The purpose is to break the periodicities leading to grating lobes. Therefore, in certain embodiments, the 3D imaging sonar system 100 comprises a circular array or concentric circular arrays with irregular element spacing. Such irregularity may be introduced either as variation in the azimuth spacing 200 within each circular array or as variation in the radial position of each array element or as both. For a circular array with nominal radius R, element positions may be allowed to vary in a band around R between, say Rₘᵢₙ and Rₘₐₓ. With N elements in the array, the nominal angular spacing (in radians) wound be 2π/N. The angular element spacing may be allowed to vary by some fraction of this nominal spacing. The deviations from the nominal element positions may be optimized by the methods above, subject to the additional constraints that radii are within their respective bands (between Rₘᵢₙ and Rₘₐₓ) and that element spacings are above some minimum to avoid overlap between elements.

Although the embodiments of the 3D imaging sonar system 100 have been described in conjunction with circular arrays 120, it will be understood that this also encompasses certain modifications and generalizations such as the expansion of the circular array into a circular band or deforming to an ellipse or oval (or other geometries that are essentially circular, and/or when the array performance is essentially that of a circular array).

Another variation would be to design the array as a polygon. Strictly speaking, an N-element circular array can be described as an N-sided polygon. Polygons with fewer than N sides, such as hexagons, heptagons, octagons, etc., may serve as approximations to the circular array and thus “circular array” would include such circular array approximations, geometries that are essentially circular, and/or when the array performance is essentially that of a circular array.

In certain embodiments, the 3D imaging sonar system 100 is also configured to measure the Doppler shift associated with each detected surface point. In these embodiments, the transmitter/projector 110 transmits at least two identical pulses instead of one. These pulses may be short narrow-band bursts or wide-band code words such as chirps or PSK codes. The pulses are separated by a known time lag. The received signal in each beam may then be searched with a similarity measure, such as the autocorrelation at the transmitted time lag, to find coherent surfaces. This offers an alternative to simple amplitude detection, yielding, for two pulses, a single peak associated with each detectable surface. The phase of the complex autocorrelation function at the detected range yields the Doppler shift.

The Doppler shift measured at an image point represents a projection of the 3D velocity vector onto the beam direction to that point. With a very large number of image points but only 3 velocity components, there is a large amount of redundant velocity information. This redundancy may be exploited to resolve biases in the beam directions, where the actual direction of arrival may differ slightly from the intended steering direction. Therefore, in certain embodiments, the velocity vector, and the bathymetry (3D point cloud) are found through a co-optimization process. This process may include algorithms to find the precise angle of arrival within each beam. Several such algorithms are described in the literature.

With reference to FIGS. 7 and 8, an exemplary bathymetry-only process to generate a 3D point cloud from echoes of a single ping and an exemplary combined bathymetry and Doppler process to generate a 3D point cloud from a single ping and find Doppler shifts include the steps of:
1) Emission/Projection: The wide opening angle projector 110 emits/projects at least one pulse of acoustic energy into a body of water. Each pulse first intersects the seabed (or object to be imaged) as a spot at nadir angle and then expands as a circle with radius increasing with time.
2) Reception: The backscattered acoustic energy from the body of water or echoes of each pulse are received by the transducer elements 125 of the circular array 120.
3) Beamforming: The received signals are combined e.g., by Delay and Sum or steering vector beamforming procedure/process/algorithm, to create a plurality of directional receive channels or construct a multitude of beams covering the image's field of view. The beam spacing is typically set smaller than the beams' spot size to optimize image resolution.
4) Detection: The signal in each constructed beam is analyzed by a detection procedure/process/algorithm aiming to identify reflective surfaces. The detection process searches for high reflectivity objects in each of the directional receive channels and associates a range to each detected high reflectivity object calculated from the time of flight. This may involve a simple procedure/process/algorithm looking for signal amplitude above a threshold. In cases where repeated pulses are transmitted, detection metrics based on autocorrelation may also be used. Detected surfaces may include the seabed, objects on the seabed or objects suspended in the water column. The range to each detected object is found by the time of flight. Along with the beam directions, this yields (e.g., by combining the range and direction to each detected high reflectivity object) the necessary information to create/generate a 3D point cloud, providing a detailed image of the underwater environment.
5) Doppler shift calculation: As shown in FIG. 8, in cases where two or more identical pulses have been transmitted, a Doppler shift may be computed, e.g., from the complex autocorrelation phase, for each beam. These Doppler shifts represent projections of the velocity vector (relative velocity between the instrument and the imaged objects) onto the respective beam directions 300,320. This provides abundant information to resolve the instrument's velocity relative to the seabed and/or objects in the water column.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus, the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

We claim:

1. An underwater SONAR system, comprising:
at least one wide-angle projector configured to project acoustic signals; and
at least one circular receiver array of elements configured to receive backscattering of the projected acoustic signals.

2. The underwater SONAR system of claim 1, wherein the at least one wide-angle projectors are dome-shaped transducers.

3. The underwater SONAR system of claim 1, wherein the at least one wide-angle projectors are cylinder-shaped transducers.

4. The underwater SONAR system of claim 1, wherein the at least one wide-angle projectors are phased arrays comprising concentric ring transducers.

5. The underwater SONAR system of claim 1, wherein the elements of the at least one circular receiver array comprise flat, substantially square elements of dimensions on the order of half a wavelength of the center frequency of the projected signal.

6. The underwater SONAR system of claim 1, wherein the elements of the at least one circular receiver array have the shape of toroidal sections with the element spacing in the circumferential direction being substantially half a wavelength of the center frequency of the projected signal, and the radial element length is substantially longer.

7. The underwater SONAR system of claim 1, wherein element spacing of the at least one circular receiver array is substantially longer than half a wavelength of the center frequency of the projected signal.

8. The underwater SONAR system of claim 7, where the elements of the at least one circular receiver array have surfaces with curvature both in the azimuth and radial directions.

9. The underwater SONAR system of claim 1, wherein the at least one wide-angle projector is N projectors with N>1, where the N projectors are optimized for projecting acoustic energy in separate frequency bands, and where the number of circular receiver arrays is ≥N, with the elements of the at least one circular receiver array include a plurality of circular receiver arrays arranged as concentric circles.

10. A method for creating a 3D SONAR image with the underwater SONAR system of claim 1, comprising:
projecting at least one pulse of acoustic energy into a body of water with the wide-angle projector;
receiving backscattered acoustic energy from the body of water with the elements of the at least one circular receiver array;
combining the signals received by the elements of the at least one circular receiver array by a beamforming process so as to create a plurality of directional receive channels;
applying a detection process to search for high reflectivity objects in each of the directional receive channels and associating a range to each detected high reflectivity object calculated from the time of flight;
combining the range and direction to each detected high reflectivity object to create a 3D point cloud.

11. The method of claim 10, where the at least one pulse of acoustic energy projected into a body of water are two pulses transmitted with a predetermined time lag between them, and where the detection process is based, at least in part, on the autocorrelation function of the received signal calculated at, or near, the predetermined time lag.

12. The method of claim 11, further comprising calculating a Doppler shift associated with each detected high reflectivity object.

13. The method of claim 11, further comprising calculating a direction of arrival associated with each detected high reflectivity object.

14. The method of claim 11, further comprising co-optimization steps where the coordinates of points in the 3D point cloud belonging to solid objects and the velocity vector associated with said objects are adjusted to minimize a total error.
